(19) United States
(12) Patent Application Publication
(10) Pub. No.: US 2012/0215713 A1
(43) Pub. Date: Aug. 23, 2012

(54) End of Assembly Line Test System Internal To Vehicle Controllers

(75) Inventors: Robert C. Moore, Dickeyville, WI (US); Lance R. Sherlock, Asbury, IA (US); Yu Wentao, Dubuque, IA (US)

(73) Assignee: DEERE & COMPANY, Moline, IL (US)

(21) Appl. No.: 13/093,427

(22) Filed: Apr. 25, 2011

Related U.S. Application Data
(60) Provisional application No. 61/445,478, filed on Feb. 22, 2011.

(51) Int. Cl. G01M 17/00; G06Q 99/00; G06F 19/00

(52) U.S. Cl. 705/330; 700/110; 701/22

(57) ABSTRACT

A vehicle is provided having a controller and a controller interface configured to control the vehicle. The controller that is provided to operate the vehicle is also provided with software usable for quality assurance testing of various vehicle portions.

### FIELD

The present disclosure relates to assembly line testing of a completed vehicle, and more particularly to a system and method for testing a completed vehicle, wherein the testing system is integrated into the controllers of the vehicle.

BACKGROUND AND SUMMARY

When any product, including a work machine, is produced, it is a generally accepted good practice to test one or more of each run for quality assurance purposes. Such testing can take the form of actually using the device, a visual inspection, or otherwise. For some electronic devices, or devices containing software, a visual inspection will not suffice to fully test the device. For some work machines, a distinct testing stand may be produced for the purposes of attaching it to a completed work machine to perform diagnostic procedures for detecting proper operation of various vehicle systems. This test stand is a stand-alone device that is hooked up to completed work machines to be able to access and test the electronic workings and software workings of the work machine. Thus, the test stand is a fully separate system that needs its own designing, building, and maintenance. Additionally, as the work machines being tested are changed and/or improved, similar changes and updates may be necessary for the test stand. Accordingly, what is needed is the ability to test work machines without the above noted drawbacks.

According to an embodiment of the present disclosure, a vehicle is provided including: a chassis; a ground engaging mechanism configured to support the chassis; an electric motor configured to drive the ground engaging mechanism; a power source configured to provide power to the electric motor; a controller configured to control the electric motor and other vehicle systems, the controller including a processor, an electronic storage device fixedly integrated into the vehicle and having software thereon. When invoked via the controller, the software causes the controller to execute the steps of: instructing a user to perform steps to activate a first vehicle feature; recording electronic communications indicative of whether the steps to activate the first vehicle feature were taken; instructing the user to indicate whether the first vehicle feature was activated as expected in response to the steps taken to activate the first vehicle feature; determining whether the recorded communications and user input indicate a passing or failing of the first vehicle feature; and storing the determination on the electronic storage device.

According to another embodiment of the present disclosure, a method of testing work machine assembly is provided including the steps of: fixedly coupling a work machine control interface into the work machine such that the control interface is fixedly mounted within a cab of the work machine and readily accessible to an operator of the work machine seated in a seat located in the cab; providing a control system electrically coupled to the work machine control interface, the control system being coupled to an electronic storage device; and using the control interface to access programming stored on the electronic storage device. The programming causing the control system to perform the steps of: instructing a user to perform steps to activate a first vehicle feature; recording electronic communications indicative of whether the steps to activate the first vehicle feature were taken; instructing the user to indicate whether the first vehicle feature was activated as expected in response to the steps taken to activate the first vehicle feature; determining whether the recorded communications and user input indicate a passing or failing of the first vehicle feature; and storing the determination on the electronic storage device.

According to yet another embodiment of the present disclosure, a method of assembling a work machine is provided including the steps of: receiving a work machine frame; attaching a control system interface and a control system electrically to an electronic storage device and physically to the frame, the control system interface including a screen viewable by a user; attaching a first accessory physically to the work machine frame and electronically to the control system and control system interface; using the control system interface to invoke programming stored on the electronic storage device. The programming causing the control system to test the first accessory by: instructing a user to interact with the control system interface to call for operation of the first accessory, determining if desired signals were sent to the first accessory; and requesting that the user indicate whether the first accessory performed as desired. The method further including the steps of attaching a second accessory physically to the work machine frame and electronically to the control system and control system interface after the first accessory is tested; and using the control system interface to invoke programming stored on the electronic storage device to cause the control system to test the second accessory by: instructing a user to interact with the control system interface to call for operation of the second accessory, determining if desired signals were sent to the second accessory; and requesting that the user indicate whether the second accessory performed as desired.

### BRIEF DESCRIPTION OF THE DRAWINGS

The above-mentioned and other features and advantages of the invention, and the manner of attaining them, will become more apparent and the disclosure itself will be better understood by reference to the following description taken in conjunction with the accompanying drawings, wherein:

FIG. 1 illustrates an exemplary vehicle incorporating the integral end of line testing module of the present disclosure;

FIG. 2 illustrates a representative view of an exemplary user interface of the vehicle of FIG. 1;

FIG. 3 shows electronic systems coupled to and controllable via the interface of FIG. 2; and

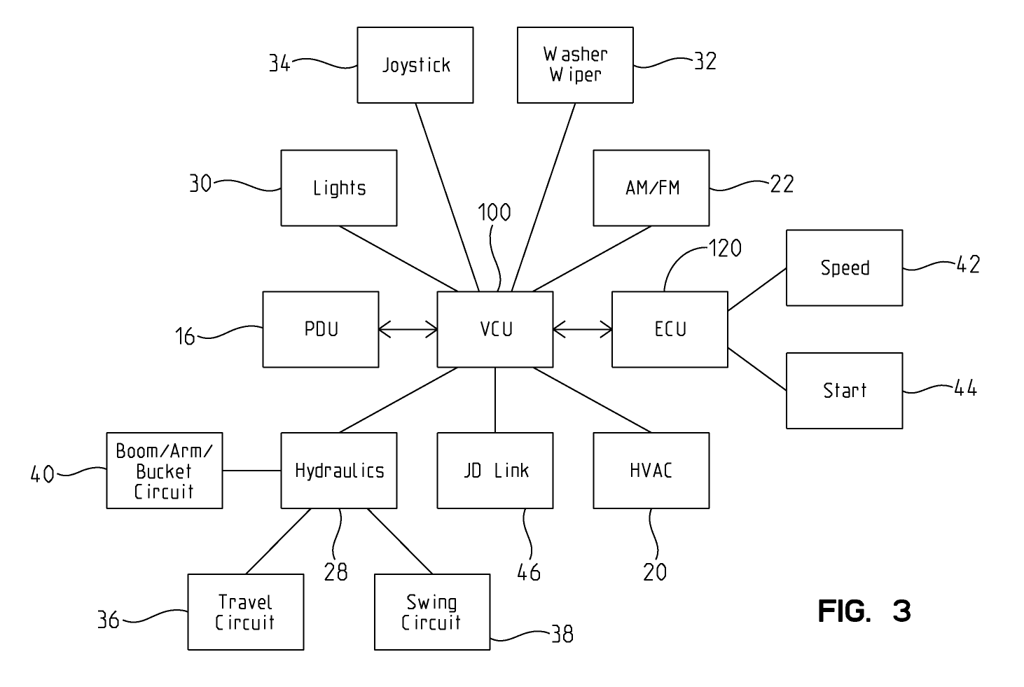

FIG. 4 is a flowchart illustrating steps taken as an end of line testing protocol is implemented;

Corresponding reference characters indicate corresponding parts throughout the several views. The exemplifications set out herein illustrate exemplary embodiments of the invention, and such exemplifications are not to be construed as limiting the scope of the invention in any manner.

### DETAILED DESCRIPTION

The embodiments disclosed herein are not intended to be exhaustive or to limit the disclosure to the precise forms disclosed in the following detailed description. Rather, the embodiments are chosen and described so that others skilled in art may utilize their teachings.

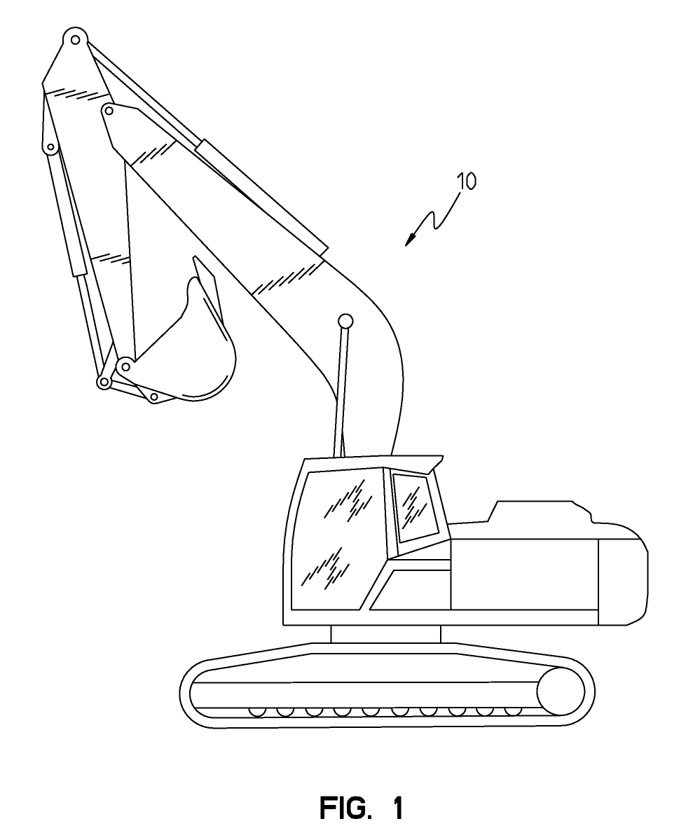

Referring to FIG. 1, an exemplary work vehicle in the form of excavator 10 is provided. Although the utility vehicle is illustrated and described herein as excavator 10, the utility vehicle may include a loader, motor grader, tractor, a bulldozer, a feller buncher, a crawler, a skidder, a forwarder, or another utility vehicle. Excavator 10 includes a chassis 12 and a ground drive element or ground engaging mechanism 14. Ground engaging mechanism 14 is capable of supporting chassis 12 and propelling chassis 12 across the ground 15. Although the illustrated excavator 10 includes tracks as ground engaging mechanism 14, excavator 10 may include other ground engaging mechanisms, such as wheels or other suitable ground engaging members.

Excavator 10 further includes Vehicle Control Unit (VCU) 100 and Engine Control Unit (ECU) 120 controllable via Primary Display Unit (PDU) 16. VCU 100 controls many features of excavator 10 such as Automatic Temperature Controlled (ATC) HVAC unit 20, AM/FM/Weather band radio 22, hydraulic systems 28, lights 30, washer/wipers 32, joystick controllers 34, and many additional electrical components. ECU 120 determines the amount of fuel, ignition timing and other parameters an internal combustion engine needs to keep running ECU 120 reads values from multidimensional performance maps and uses input values (e.g. engine speed) calculated from signals coming from sensor devices monitoring the engine.

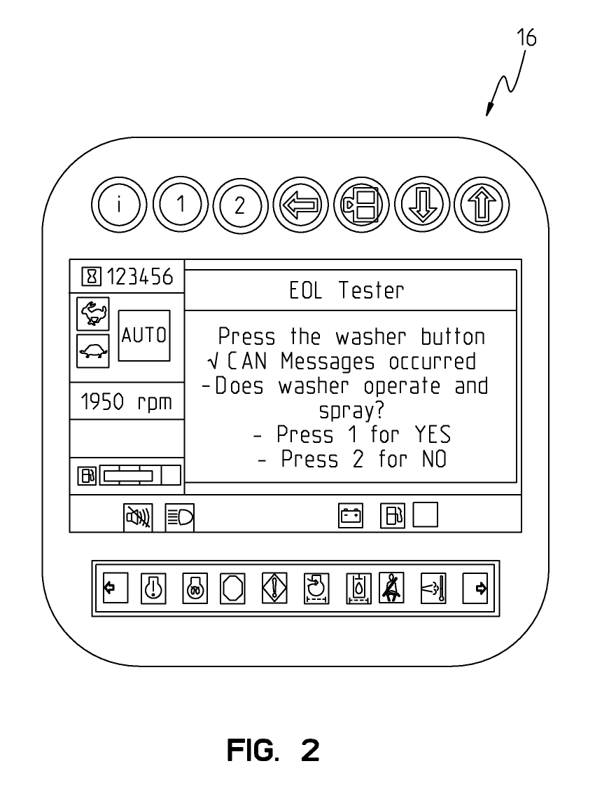

As illustrated in FIG. 2, PDU 16 provides a user interface for the electronics and software employed on excavator 10. PDU 16, is electronically coupled to VCU 100 and ECU 120.

PDU 16 includes a service mode 24. Within service mode 24 is test stand module 26. PDU 16 operates via a Controller-area network (CAN or CAN-bus). CAN is a vehicle bus standard designed to allow microcontrollers and devices to communicate with each other within a vehicle without a host computer. The CAN is accessible via a JDLink Service ADVISOR connector 46 to which PDU 16 is linked.

Test stand module 26 provides programming to test the functionality of various excavator 10 functions. The assembly of excavator 10 provides that many different systems of excavator 10 may be assembled at many geographically dispersed locations. At the conclusion of the assembly of a portion of excavator 10, that portion is tested. As previously noted, the use of external, stand-alone testing stands requires that multiple test stands be provided at each of the various geographically dispersed assembly locations. Furthermore, multiple test stands are necessary within an assembly plant to correspond to each system assembly testing point. PDU 16 of the present disclosure provides the testing software traditionally present on test stand integrally with the PDU 16 and thus excavator 10. Accordingly, excavator 10 of the present disclosure does not require the manufacturing locations to provide test stands.

In one embodiment, the test stand module within PDU 16 consists of a single program that executes all tests of excavator 10 at a single time. In another embodiment, the test stand module within PDU 16 is broken into multiple test protocols such that less than all available tests are run at any one time. Such an embodiment is implemented in the case where the assembly of excavator 10 occurs at multiple geographically dispersed locations. However, such an embodiment is also implemented for assembly that occurs in a single geographic location where distinct testing is desired at multiple sub-assembly completion sites.

As previously discussed, (ATC) HVAC unit 20, AM/FM/Weather band radio 22, hydraulic systems 28, lights 30, washer/wipers 32, joystick controllers 34, and many additional electrical components are each tested either alone, grouped together in modules, or all grouped together. Embodiments of such tests are shown in FIGS. 5a-n and described below. Each of FIGS. 5a-n show PDU 16 displayed text, PDU 16 displayed user response options, and VCU software actions performed in response to the user response.

Lights 30 are tested to ensure that all installed lights are operating correctly. The test also ensures that the proper lights are enabled for the particular excavator 10 under test. As shown in FIG. 5a, the test of lights 30 starts with displaying the question “All work lights off?” 510 to a user via PDU 16. The user is further shown indications that responding by pressing “1” on PDU 16 indicates an affirmative answer to the question and pressing 2 on PDU 16 indicates a negative answer to the question. VCU 100 retains the user's input and then proceeds to the next step 520. Step 520 instructs the user to “Press the SSM Work Light Button.” VCU 100 then records and verifies the CAN messaging indicating that the instructed step was taken. VCU 100 then

Excavator 10 is first configured to ready it for testing. According to serialization protocols, a VIN for excavator 10 is obtained. The machine VIN is entered via operator input and the chosen options for the specific excavator being built are input through an ECU_Controller program on a bench setup. This is completed prior to the VCU being installed in the excavator. This shall be completed prior to the VCU being installed in the excavator.

Subsequently, engine controllers are programmed in the factory to match the specific engine. This is also completed through the ECU_Controller program on a bench setup prior to the VCU being installed in the excavator.

The VCU normally arrives with the correct software pre-installed. However, there are occasions when software updates are made for many potential reasons. Due to the time involved in shipping VCU's from the supplier to the factory, there will likely be times when the VCU needs to be re-programmed to get the correct software.

Once setup and correctly programmed, the VCU and ECU are installed on the excavator 10. This installation includes coupling VCU and ECU to PDU 16. Once all of the controllers are installed, a clear codes activity is completed to remove all diagnostic trouble codes from the bench top programming.

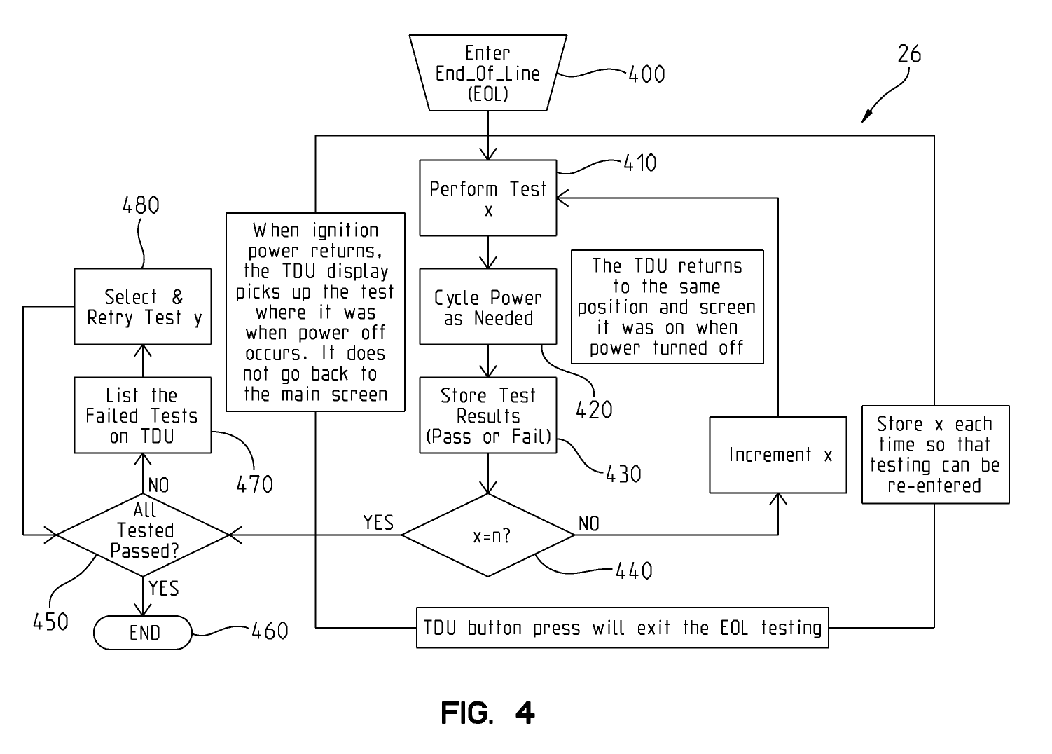

For any testing, whether being performed as single instance covering all tests, or any module consisting of less than all available tests, the protocol of FIG. 4 is followed. Once test stand module is invoked within PDU 16, exiting this module will only be allowed once all tests have successfully passed or by invoking a back-door exit. Step 400 provides for the invoking of the particular testing module. Step 410 invokes a particular test within the chosen test module (test “x”). When immediately following step 400, step 410 invokes the first test of the module (x=1). Embodiments of the modules are provided below. If necessary, step 420 cycles the power of excavator 10. The pass/fail status of the test is stored at step 430. Step 440 determines if all tests within the module have been run (n=number of tests within the module). If all tests within the module have not been run, steps 410-440 are cycled until all tests in the module have been run.

If all tests have been run analysis of the tests begins at step 450 that asks if all tests were passed. If so, the program ends at step 460. If not, the failed tests are displayed at step 470 and the user is given the option to re-run the failed test, step 480. If a test repeatedly fails, the user utilizes the backdoor exit to end the program.

Test embodiments are listed below.

Lights testing:

If only Boom and Frame lights are present (determined by looking at VCU memory access values) the following test script and the corresponding software actions are presented on PDU 16 and executed by VCU 100 to test the lights:

| End Of Line Testing | Responses | VCU Software Actions |
|---|---|---|
| 1: All work lights off? | 1 = Yes, 2 = No | 1: Retain user input |
| 2: Press SSM Work Light Button | | 2: Record & verify CAN messaging |
| 3: Does monitor alarm sound? | 1 = Yes, 2 = No | 3: Retain user input |
| 4: Only the Boom and the Frame Light | 1 = Yes, 2 = No | 4: Retain user input |
| on? | | |
| 5: Press SSM Work Light Button | | 5: Record & verify CAN messaging |
| 6: All work lights off? | 1 = Yes, 2 = No | 6: Retain user input |
| Work Light Test Status | PASS or FAIL | Based upon seeing the correct CAN |
| | | messages and all user input answers |
| | | being yes, then “PASS” Else “FAIL” |

If Boom, Frame, and Front Cab lights are present (per VCU memory access values) the following test script is presented on PDU 16 to test the lights:

| End Of Line Testing | Responses | VCU Software Actions |
|---|---|---|
| 1: All work lights off? | 1 = Yes, 2 = No | 1: Retain user input |
| 2: Press SSM Work Light Button | | 2: Record & verify CAN messaging |
| 3: Are only the Boom and the Frame Light | 1 = Yes, 2 = No | 3: Retain user input |
| on? | | |
| 4: Press SSM Work Light Button | | 4: Retain user input |
| 5: Only Boom, Frame, and Front Cab lights | 1 = Yes, 2 = No | 5: Record & verify CAN messaging |
| on? | | |
| 6: Press SSM Work Light Button | | 6: Retain user input |
| 7: All work lights off? | 1 = Yes, 2 = No | |
| Work Light Test Status | PASS or FAIL | Based upon seeing the correct CAN |
| | | messages and all user input answers |
| | | being yes, then “PASS” Else “FAIL” |

If Boom, Frame, Front Cab, and Rear Cab lights are present (per VCU memory access values) the following test script is presented on PDU 16 to test the lights:

| End Of Line Testing | Responses | VCU Software Actions |
|---|---|---|
| 1: All work lights off? | 1 = Yes, 2 = No | 1: Retain user input |
| 2: Press SSM Work Light Button | | 2: Record & verify CAN messaging |
| 3: Are only the Boom and the Frame Light | 1 = Yes, 2 = No | 3: Retain user input |
| on? | | |
| 4: Press SSM Work Light Button | | 4: Record & verify CAN messaging |
| 5: Only Boom, Frame, and Front Cab lights | 1 = Yes, 2 = No | 5: Retain user input |
| on? | | |
| 6: Press SSM Work Light Button | | 6: Record & verify CAN messaging |
| 7: All work lights on? | 1 = Yes, 2 = No | 7: Retain user input |
| 8: Press SSM Work Light Button | | 8: Record & verify CAN messaging |
| 9: All work lights off? | 1 = Yes, 2 = No | 9: Retain user input |
| Work Light Test Status | PASS or FAIL | Based upon seeing the correct CAN |
| | | messages and all user input answers |
| | | being yes, then “PASS” Else “FAIL” |

Washer & Wiper Systems Testing

The following test script and the corresponding software actions are presented on PDU 16 and executed by VCU 100 to test an upper wiper system:

| End Of Line Testing | Responses | VCU Software Actions |
|---|---|---|
| 1: All wipers off? | 1 = Yes, 2 = No | 1: Retain user input |
| 2: Press SSM Upper Wiper Button | | 2: Record & verify CAN messaging |
| 3: Only the Upper Wiper on intermittently? | 1 = Yes, 2 = No | 3: Retain user input |
| 4: Press SSM Upper Wiper Button | | 4: Record & verify CAN messaging |
| 5: Only the Upper Wiper on continuously? | 1 = Yes, 2 = No | 5: Retain user input |
| 6: Press SSM Upper Wiper Button | | 6: Record & verify CAN messaging |
| 7: Does the Upper Wiper move to park off | 1 = Yes, 2 = No | 7: Retain user input |
| of the window? | | |
| Upper Wiper Test Status | PASS or FAIL | Based upon seeing the correct CAN |
| | | messages and all user input answers |
| | | being yes, then “PASS” Else “FAIL” |

The following test script and the corresponding software actions are presented on PDU 16 and executed by VCU 100 to test an upper washer system:

| End Of Line Testing | Responses | VCU Software Actions |
|---|---|---|
| 1: All wipers off? | 1 = Yes, 2 = No | 1: Retain user input |
| 2: Press & hold SSM Upper Washer Button | | 2: Record & verify CAN messaging |
| for 5 seconds | | |
| 3: Only the Upper Wiper on continuously? | 1 = Yes, 2 = No | 3: Retain user input |
| 4: Only the Upper Washer sprays fluid? | 1 = Yes, 2 = No | 4: Retain user input |
| 5: Release the Upper Washer Button | | 5: Record & verify CAN messaging |
| 6: Does the Upper Wiper move to park off | 1 = Yes, 2 = No | 6: Retain user input |
| of the window? | | |
| Upper Washer Test Status | PASS or FAIL | Based upon seeing the correct CAN |
| | | messages and all user input answers |
| | | being yes, then “PASS” Else “FAIL” |

The following test script and the corresponding software actions are presented on PDU 16 and executed by VCU 100 to test a lower wiper system (if installed, as determined by interpreting the VIN):

| End Of Line Testing | Responses | VCU Software Actions |
|---|---|---|
| 1: All wipers off? | 1 = Yes, 2 = No | 1: Retain user input |
| 2: Press SSM Lower Wiper Button | | 2: Record & verify CAN |
| | | messaging |
| 3: Only the Lower Wiper on intermittently? | 1 = Yes, 2 = No | 3: Retain user input |
| 4: Press SSM Lower Wiper Button | | 4: Record & verify CAN |
| | | messaging |
| 5: Only the Lower Wiper on continuously? | 1 = Yes, 2 = No | 5: Retain user input |
| 6: Press SSM Lower Wiper Button | | 6: Retain user input |
| 7: Does the Lower Wiper move to park off of the | 1 = Yes, 2 = No | 7. Record & verify CAN |
| window? | | messaging |
| Lower Wiper Test Status | PASS or FAIL | Based upon seeing the correct |
| | | CAN messages and all user input |
| | | answers being yes, then “PASS” |
| | | Else “FAIL” |

The following test script and the corresponding software actions are presented on PDU 16 and executed by VCU 100 to test a lower washer system (if installed, as determined by interpreting the VIN):

| End Of Line Testing | Responses | VCU Software Actions |
|---|---|---|
| 1: All wipers off? | 1 = Yes, 2 = No | 1: Retain user input |
| 2: Press & hold SSM Upper Washer Button | | 2: Record & verify CAN messaging |
| for 5 seconds | | |
| 3: Only the Upper Wiper on continuously? | 1 = Yes, 2 = No | 3: Retain user input |
| 4: Only the Upper Washer sprays fluid? | 1 = Yes, 2 = No | 4: Retain user input |
| 5: Release the Upper Washer Button | 1 = Yes, 2 = No | 5: Retain user input |
| 6: Does the Upper Wiper move to park off of | 1 = Yes, 2 = No | 6: Retain user input |
| the window? | | |
| Lower Washer Test Status | PASS or FAIL | Based upon seeing the correct CAN |
| | | messages and all user input answers |
| | | being yes, then “PASS” Else “FAIL” |

Start Engine:

The following test script and the corresponding software actions are presented on PDU 16 and executed by ECU 120 and VCU 100 to test the engine starting ability 44:

| End Of Line Testing | Responses | VCU Software Actions |
|---|---|---|
| 1: Engine not running? | 1 = Yes, 2 = No | 1: Retain user input |
| 2: Press SSM Start Button | | 2: Record & verify CAN messaging |
| 3: Press horn button on left joystick | | 3: Record & verify CAN messaging |
| 4: Does horn sound? | 1 = Yes, 2 = No | 4: Retain user input |
| 5: Press SSM Start Button | | 5: Record & verify CAN messaging |
| 6: Is engine running? | 1 = Yes, 2 = No | 6: Retain user input |
| 7: Press the SSM Stop Button | | 7: Record & verify CAN messaging |
| 8: Engine not running? | 1 = Yes, 2 = No | 8: Retain user input |
| Engine Start Test Status | PASS or FAIL | Based upon seeing the correct CAN |
| | | messages and all user input answers being |
| | | yes, then “PASS” Else “FAIL” |

Engine Speed Controls

The following test script and the corresponding software actions are presented on PDU 16 and executed by ECU 120 and VCU 100 to test the engine speed controls 42:

| End Of Line Testing | Responses | VCU Software Actions |
|---|---|---|
| 1: Press SSM Start Button | | 1: Record & verify CAN messaging |
| 2: Press SSM Start Button | | 2: Record & verify CAN messaging |
| 3: Is engine running? | 1 = Yes, 2 = No | 3: Retain user input |
| 4: Starting with the throttle dial in lowest position, move | | 4: Record & verify CAN messaging |
| dial 1 click every 5 seconds | | |
| 5: Press the left joystick decel trigger | | 5: Record & verify CAN messaging |
| 6: Engine at low idle? | 1 = Yes, 2 = No | 6: Retain user input |
| 7: Press the left joystick decel trigger | | 7: Record & verify CAN messaging |
| 8: Engine at high idle? | 1 = Yes, 2 = No | 8: Retain user input |
| 9: Move dial back to lowest position | | 9: Record & verify CAN messaging |
| 10: Press the SSM Stop Button | | 10: Record & verify CAN messaging |
| 11: Movement on the Work Mode gage? | 1 = Yes, 2 = No | 11: Retain user input |
| 12: Engine not running? | 1 = Yes, 2 = No | 12: Retain user input |
| Engine Start Test Status | PASS or FAIL | Based upon seeing the correct CAN |
| | | messages and all user input answers |
| | | being yes, then “PASS” Else “FAIL” |

HVAC Controls

The following test script and the corresponding software actions are presented on PDU 16 and executed by VCU 100 to test the HVAC system 20:

| End Of Line Testing | Responses | VCU Software Actions |
|---|---|---|
| 1: Press SSM Start Button | | 1: Record & verify CAN |
| | | messaging |
| 2: Is the HVAC area on the PDU empty? | 1 = Yes, 2 = No | 2: Retain user input |
| 3: Press SSM Start Button | | 3: Record & verify CAN |
| | | messaging |
| 4: Is engine running? | 1 = Yes, 2 = No | 4: Retain user input |
| 5: Press SSM HVAC SSM Button | | 5: Record & verify CAN |
| | | messaging |
| 6: Does the HVAC area on the PDU show symbols? | 1 = Yes, 2 = No | 6: Retain user input |
| 7: Starting with the blower speed at minimum, press the Fan | | 7: Record & verify CAN |
| Speed + SSM button once every 5 seconds | | messaging |
| 8: Does fan speed increase & does display indicate | 1 = Yes, 2 = No | 8: Retain user input |
| increase? | | |
| 9: Press the Air Mode Button on the SSM every 5 seconds | | 9: Record & verify CAN |
| | | messaging |
| 10: Does the air output move and does the monitor display | 1 = Yes, 2 = No | 10: Retain user input |
| modes? | | |
| 11: Press & hold the Temp + SSM button to max value | | 11: Record & verify CAN |
| | | messaging |
| 12: Hot air coming out of vents? | 1 = Yes, 2 = No | 12: Retain user input |
| 13: Press and hold the Temp—SSM button to min value | | 13: Record & verify CAN |
| | | messaging |
| 14: Press the ATC SSM Button | | 14: Record & verify CAN |
| | | messaging |
| 15: Cold air coming out of vents? | 1 = Yes, 2 = No | 15: Retain user input |
| 16: Press SSM HVAC SSM Button | | 16: Record & verify CAN |
| | | messaging |
| 17: Does the HVAC area on the PDU show symbols? | 1 = Yes, 2 = No | 17: Retain user input |
| HVAC Test Status | PASS or FAIL | Based upon seeing the correct |
| | | CAN messages and all user input |
| | | answers being yes, then “PASS” |
| | | Else “FAIL” |

Hydraulic Checks

The following test script and the corresponding software actions are presented on PDU 16 and executed by VCU 100 to test the hydraulic travel circuits 36:

| End Of Line Testing | Responses | VCU Software Actions |
|---|---|---|
| 1: Start Engine | | 1: Record & verify CAN |
| | | messaging |
| 2: With Hydraulic Pilot Enable level down, press the travel | | 2: Record & verify CAN |
| sticks forward | | messaging |
| 3: Does the track or sprocket turn forward? | 1 = Yes, 2 = No | 3: Retain user input |
| 4: Is the SSM Travel Switch on low and does the monitor | 1 = Yes, 2 = No | 4: Retain user input |
| show low travel speed? | | |
| 5: Raise Hydraulic Enable lever | | 5: Record & verify CAN |
| | | messaging |
| 6: Press the travel sticks forward | | 6: Record & verify CAN |
| | | messaging |
| 7: Does the track or sprocket turn in forward? | 1 = Yes, 2 = No | 7: Retain user input |
| 8: Release the travel sticks | | 8: Record & verify CAN |
| | | messaging |
| 9: Do the tracks or sprockets stop turning? | 1 = Yes, 2 = No | 9: Retain user input |
| 10: Press the SSM Travel button twice to move to High | | 10: Record & verify CAN |
| speed | | messaging |
| 11: Pull the travel sticks reverse | 1 = Yes, 2 = No | 11: Retain user input |
| 12: Does the track or sprocket turn in reverse? | 1 = Yes, 2 = No | 12: Retain user input |
| 13: Release the travel sticks | | 13: Record & verify CAN |
| | | messaging |
| 14: Do the tracks or sprockets stop turning? | 1 = Yes, 2 = No | 14: Retain user input |
| Travel Circuit Test Status | PASS or FAIL | Based upon seeing the correct |
| | | CAN messages and all user |
| | | input answers being yes, then |
| | | “PASS” Else “FAIL” |

The following test script and the corresponding software actions are presented on PDU 16 and executed by VCU 100 to test the hydraulic swing circuits 38:

| End Of Line Testing | Responses | VCU Software Actions |
|---|---|---|
| 1: Start Engine | | 1: Record & verify CAN |
| | | messaging |
| 2: Enable Hydraulics | | 2: Record & verify CAN |
| | | messaging |
| 3: Push left hand joystick to full right position | | 3: Record & verify CAN |
| | | messaging |
| 4: Does house move to the right? | 1 = Yes, 2 = No | 4: Retain user input |
| 5: After complete revolution, release left hand joystick | | 5: Record & verify CAN |
| | | messaging |
| 6: Does house stop moving? | 1 = Yes, 2 = No | 6: Retain user input |
| 7: Push left hand joystick to full left position | | 7: Record & verify CAN |
| | | messaging |
| 8: Does house move to the left? | 1 = Yes, 2 = No | 8: Retain user input |
| 9: After complete revolution, release left hand joystick | | 9: Record & verify CAN |
| | | messaging |
| 10: Does house stop moving? | 1 = Yes, 2 = No | 10: Retain user input |
| Swing Circuit Test Status | PASS or FAIL | Based upon seeing the correct |
| | | CAN messages and all user |
| | | input answers being yes, then |
| | | “PASS” Else “FAIL” |

Hydraulic Boom, Arm, Bucket Circuit Checks

The following test script and the corresponding software actions are presented on PDU 16 and executed by VCU 100 to test the hydraulic boom, arm, and bucket circuits 40:

| End Of Line Testing | Responses | VCU Software Actions |
|---|---|---|
| 1: Start Engine | | 1: Record & verify CAN |
| | | messaging |
| 2: Enable Hydraulics | | 2: Record & verify CAN |
| | | messaging |
| 3: Pull right hand joystick | | 3: Record & verify CAN |
| to full back position | | messaging |
| Hydraulic Test Status | PASS or | Based upon seeing the correct |
| | FAIL | CAN messages and all user |
| | | input answers being yes, then |
| | | “PASS” Else “FAIL” |

Diagnostic Trouble Code Checks

The following test script and the corresponding software actions are presented on PDU 16 and executed by VCU 100 to test the diagnostic trouble code checks:

| End Of Line Testing | Responses | VCU Software Actions |
|---|---|---|
| 1: Press 1 to clear all active & stored codes | | 1: Record & verify CAN |
| | | messaging & Retain User Input |
| 2: Once complete, power off machine and then back on | | |
| 3: Request codes by pressing 1 | | 3: Record & verify CAN |
| | | messaging & Retain User Input |
| 4: Display all active & stored codes | | 4: Record & verify CAN |
| | | messaging |
| 5: Write the controller that it came from (VCU, ECU, PDU, | | |
| SSM) and the code name and number. Cycle through active | | |
| codes with the NEXT button | | |
| Diagnostic Trouble Code Test Status | PASS or FAIL | Based upon seeing the correct |
| | | CAN messages and all user input |
| | | answers being yes, then “PASS” |
| | | Else “FAIL” |

Upon completion of each of the above tests, VCU 100 retains the results in a memory location that allows for memory access via CAN (Step 430). In one embodiment, the results are formatted as:
0x00→test not run, not applicable (vehicle options)
0x01→test passed first time
0x10→test failed
0x11→original test failed, but issue has since been resolved

If all tests are passed, then excavator 10 is ready to receive its electronic “birth certificate.” The birth certificate is a summary of the results of all testing that was completed. It keeps track if each individual test passed the first time or did not pass the first time and required rework. The birth certificate records the pilot pressures developed during each of the hydraulic tests, which can be used in the future to check the component life of this machine or be used to track quality levels of all parts coming in from a supplier. The birth certificate records of all DTC (Diagnostic Trouble Codes) that were present during the EOL tests. The birth certificate provides a record that the machine left the factory in working order, so that if an issue exists when the machine reaches a dealership the manufacturer knows that it occurred in shipping and work to eliminate those issues. The birth certificate records that the HVAC system is operating properly so that the manufacturer can understand potential leaks if the HVAC is no longer working after delivery to a customer. Excavator 10 is hooked up to an external computer that verifies that all tests are passed. The external computer then transfers the birth certificate to excavator 10 that verifies that all tests have been passed.

Furthermore, once a dealer receives the vehicle, the dealer can again replicate the above described tests to ensure that the vehicle is in proper working order. Any problems discovered can be compared to the test values present in the birth certificate to determine if the discovered problem is likely to have occurred during shipping.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this disclosure pertains and which fall within the limits of the appended claims.

1. A vehicle including:
a chassis;
a ground engaging mechanism configured to support the chassis;
an electric motor configured to drive the ground engaging mechanism;
a power source configured to provide power to the electric motor;
a controller configured to control the electric motor and other vehicle systems, the controller including a processor, and
a electronic storage device fixedly integrated into the vehicle and having software thereon, that when invoked via the controller causes the controller to execute the steps of:
instructing a user to perform steps to activate a first vehicle feature;
recording electronic communications indicative of whether the steps to activate the first vehicle feature were taken;
instructing the user to indicate whether the first vehicle feature was activated as expected in response to the steps taken to activate the first vehicle feature;
determining whether the recorded communications and user input indicate a passing or failing of the first vehicle feature; and
storing the determination on the electronic storage device.

2. The vehicle of claim 1, wherein the electronic storage device further has software thereon, that when invoked via the controller causes the controller to execute the steps of:
instructing a user to perform steps to activate a second vehicle feature;
recording electronic communications indicative of whether the steps to activate the second vehicle feature were taken;
instructing the user to indicate whether the second vehicle feature was activated as expected in response to the steps taken to activate the second vehicle feature;
determine whether the recorded communications and user input indicate a passing or failing of the second vehicle feature;
store the determination regarding the second vehicle feature on the electronic storage device.

3. The vehicle of claim 1, wherein the electronic storage device further has software thereon, that when invoked execute the steps of:
receiving an indication that the vehicle is connected to an external computer capable of issuing electronic records documenting a test history of the vehicle;
transmitting electronic records documenting the test history of the vehicle to the vehicle;
receiving electronic records documenting a test history of the vehicle including data thereon indicative of the tests run on the vehicle and an indication of whether such tests were passed on a first try or a subsequent try, the electronic records being stored within the electronic storage device.

4. A method of testing work machine assembly including the steps of:
fixedly coupling a work machine control interface into the work machine such that the control interface is fixedly mounted within a cab of the work machine and readily accessible to an operator of the work machine seated in a seat located in the cab;
providing a control system electrically coupled to the work machine control interface, the control system being coupled to an electronic storage device; and
using the control interface to access programming stored on the electronic storage device to cause the control system to perform the steps of:
instructing a user to perform steps to activate a first vehicle feature;
recording electronic communications indicative of whether the steps to activate the first vehicle feature were taken;
instructing the user to indicate whether the first vehicle feature was activated as expected in response to the steps taken to activate the first vehicle feature;
determining whether the recorded communications and user input indicate a passing or failing of the first vehicle feature; and
storing the determination on the electronic storage device.

5. The method of claim 4, wherein the electronic storage device further has software thereon, that when invoked via the control system causes the control system to execute the steps of:
instructing a user to perform steps to activate a second vehicle feature;
recording electronic communications indicative of whether the steps to activate the second vehicle feature were taken;
instructing the user to indicate whether the second vehicle feature was activated as expected in response to the steps taken to activate the second vehicle feature;
determine whether the recorded communications and user input indicate a passing or failing of the second vehicle feature;
store the determination regarding the second vehicle feature on the electronic storage device.

6. The method of claim 4, wherein the electronic storage device further has software thereon, that when invoked execute the steps of:
receiving an indication that the vehicle is connected to an external computer capable of issuing electronic records documenting a test history of the vehicle;
transmitting electronic records to the vehicle, the records indicating whether all administered tests are determined to have been passed;
receiving a vehicle electronic records that include data thereon indicative of the tests run on the vehicle and an indication of whether such tests were passed on a first try or a subsequent try, the vehicle birth certificate being stored within the electronic storage device.

7. The method of claim 6, further including the step of shipping the vehicle with the electronic records stored in the electronic storage device from a manufacturing assembly location to a dealer location.

8. The method of claim 7, further including the step of permitting a dealer representative to view the electronic records.

9. A method of assembling a work machine including the steps of:
receiving a work machine frame;
attaching a control system interface and a control system electrically to an electronic storage device and physically to the frame, the control system interface including a screen viewable by a user;
attaching a first accessory physically to the work machine frame and electronically to the control system and control system interface;
using the control system interface to invoke programming stored on the electronic storage device to cause the control system to test the first accessory by:
instructing a user to interact with the control system interface to call for operation of the first accessory,
determining if desired first signals were sent to the first accessory; and
requesting that the user indicate whether the first accessory performed as desired;
attaching a second accessory physically to the work machine frame and electronically to the control system and control system interface after the first accessory is tested; and
using the control system interface to invoke programming stored on the electronic storage device to cause the control system to test the second accessory by:
instructing a user to interact with the control system interface to call for operation of the second accessory,
determining if desired second signals were sent to the second accessory; and
requesting that the user indicate whether the second accessory performed as desired.

10. The method of assembly of claim 9, wherein the electronic storage device further has software thereon, that when invoked execute the steps of:
receiving an indication that the vehicle is connected to an external computer capable of issuing electronic records documenting a test history of the vehicle;
transmitting electronic records to the vehicle, the records indicating whether all administered tests are determined to have been passed;
receiving a vehicle electronic records that include data thereon indicative of the tests run on the vehicle and an indication of whether such tests were passed on a first try or a subsequent try, the vehicle birth certificate being stored within the electronic storage device.

11. The method of assembly of claim 10, further including the steps of:
shipping the vehicle to a dealer or end user;
providing for the dealer or end user to use the control system interface to invoke programming stored on the electronic storage device to cause the control system to test the first accessory by:
instructing the dealer or end user to interact with the control system interface to call for operation of the first accessory,
determining if desired signals were sent to the first accessory; and
requesting that the dealer or end user indicate whether the first accessory performed as desired.

12. The method of assembly of claim 11, further including the step of permitting the dealer or end user to compare results of the test performed by the dealer or end user to results recorded in the vehicle electronic records transmitted to the vehicle.

13. The method of assembly of claim 9, wherein the first accessory is selected from the list of lights, windshield washers, windshield wipers, engine, HVAC, and hydraulic systems.

14. The method of assembly of claim 9, wherein the control system interface includes a display monitor.

15. The method of assembly of claim 9, wherein desired first signals correspond to signals that are expected to be produced when the user interacts with the control system interface to call for operation of the first accessory.

16. The method of assembly of claim 9, wherein the control system interface and control system are exclusively provided to the work machine.
